(19) United States
(12) Patent Application Publication
(10) Pub. No.: US 2002/0074773 A1
(43) Pub. Date: Jun. 20, 2002

(54) Cargo carrier assembly

(76) Inventors: Richard W. McCoy, Granger, IN (US); Katherine A. Adams, Mishawaka, IN (US); Jason R. Moldthan, Osceola, IN (US); George O. Snook, South Bend, IN (US)

Correspondence Address: KING & SCHICKLI, PLLC, 247 NORTH BROADWAY, LEXINGTON, KY, 40507, US

(21) Appl. No.: 10/044,873

(22) Filed: Oct. 23, 2001

Related U.S. Application Data
(60) Provisional application No. 60/243,603, filed on Oct. 26, 2000.

(51) Int. Cl. B60D 1/00

(52) U.S. Cl. 280/495; 280/491.5

(57) ABSTRACT

A swinging article carrier assembly includes a mounting arm for securing to a vehicle, a swing arm pivotally secured to the mounting arm and a base pivotally secured to the swing arm. An article carrier is held on that base.

This application claims the benefit of U.S. Provisional Patent Application Serial No. 60/243,603 filed Oct. 26, 2000.

### TECHNICAL FIELD

The present invention relates generally to accessories for mounting on vehicles and, more particularly, to a swinging article carrier assembly.

### BACKGROUND OF THE INVENTION

It has long been known to construct towing hitches that are mounted to vehicles in order to allow the towing of trailers or the like. In recent years such hitches have been designed to include a receiver box having a rearwardly directed opening or cavity for the receipt of a hitch or draw bar that carries a hitch ball or other means allowing connection to a trailer. Examples of such a structure include the Insta-Hitch II and Custom Hitch Receiver 35365 as manufactured by Reese Products, Inc. of Elkhart, Ind. Such a hitch receiver is also disclosed in, for example, U.S. Pat. No. 3,768,837 to Reese, owned by Reese Products, Inc.

Recent efforts to enhance the versatility of a hitch receiver have led to development of various accessories (e.g., both open and closed article carriers, bike racks, ski racks, tables, winches or other equipment) mounted by means of an accessory mounting bar in the receiver box of a trailer hitch receiver assembly. Because of their convenience and suitability to the particular applications/interests of the user, such accessories have become very popular.

In order to allow for or accommodate trailer towing and accessory mounting simultaneously, a trailer hitch assembly with both a trailer hitch receiver and towing accessory ports has been recently developed and is the subject of, for example, U.S. patent application Ser. Nos. 60/194,502, filed Apr. 3, 2000 and Ser. No. 60/243,486 filed Oct. 26, 2000. This new trailer hitch receiver assembly includes a central frame member, a mounting bracket carried on each end of the central frame member for securing the central frame member to the vehicle, a hitch receiver box carried on the central frame member and at least one accessory receiver for receiving and holding a recreational and/or utilitarian accessory.

The present invention relates to a swinging article carrier assembly particularly adapted for mounting in a receiver box and/or accessory receiver of a receiver assembly. The carrier assembly allows the user to swing the cargo compartment of the carrier assembly from a transport position immediately adjacent the vehicle to an outboard position allowing free and easy access to a trunk or hatch of the vehicle. In addition, the cargo compartment is held on a pivoting base or platform allowing the compartment to be oriented 360° around into substantially any convenient position for loading, unloading or use as a table or the like.

### SUMMARY OF THE INVENTION

In accordance with the purposes of the present invention as described herein, a swinging article carrier assembly is provided for mounting to a motor vehicle. The swinging article carrier assembly includes a mounting arm for securing to the vehicle, a swing arm pivotally secured to the mounting arm and a base pivotally secured to the swing arm. An article carrier of substantially any configuration for carrying any type of article is held on the base. In one embodiment the article carrier includes a cargo compartment with a watertight access door.

In accordance with additional aspects of the present invention, the swing arm is pivotally connected to the mounting arm at a first end and pivotally connected to the base at a second end. The pivoting connection between the mounting arm and the swing arm is made by a clevis and a cooperating pivot pin. The pivoting connection between the swing arm and the base is made by a cooperating socket and stub shaft. A first pin may be provided for securing the mounting arm and swing arm in a closed or transport position. A second pin is provided for securing the base in a home position so that the article carrier may be secured immediately adjacent the rear of the vehicle when the mounting arm and swing arm are secured in the closed or transport position.

In the illustrated embodiment the swinging article carrier assembly is secured to the vehicle through a trailer hitch receiver assembly. More specifically, the mounting arm includes at least one mounting lug or a pair or mounting bars for securing the swinging article carrier assembly to the receiver assembly that is carried on the vehicle.

In the following description there is shown and described just one embodiment of the present invention which by way of illustration is just one of the modes best suited to carry out the invention. As it will be realized the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain the principles of the invention. In the drawings:

FIG. 1 is a perspective view showing a receiver assembly of a type that is secured to a vehicle and which is capable of receiving the swinging article carrier assembly of the present invention;

FIG. 2 is a partially exploded and partially cutaway perspective view of the swinging article carrier assembly;

FIG. 3 is a detailed top plan view showing the pivoting connection between the swing arm and mounting arm of the swinging article carrier assembly;

FIG. 4 is a top plan view illustrating the pivoting connection of the base to the swing arm;

FIG. 5 is a rear perspective view showing an article carrier in the form of a cargo compartment carried on the base;

FIG. 6 is a rear perspective view showing the swinging article carrier assembly of the present invention mounted to the rear of a vehicle with the watertight access door of the cargo compartment open; and

FIG. 7 is a schematical top plan view illustrating how the swinging article carrier is pivoted away from the rear of the vehicle to allow convenient access to the vehicle tailgate, hatch or trunk.

Reference will now be made in detail to the illustrated embodiment of the invention.

### DETAILED DESCRIPTION OF THE INVENTION

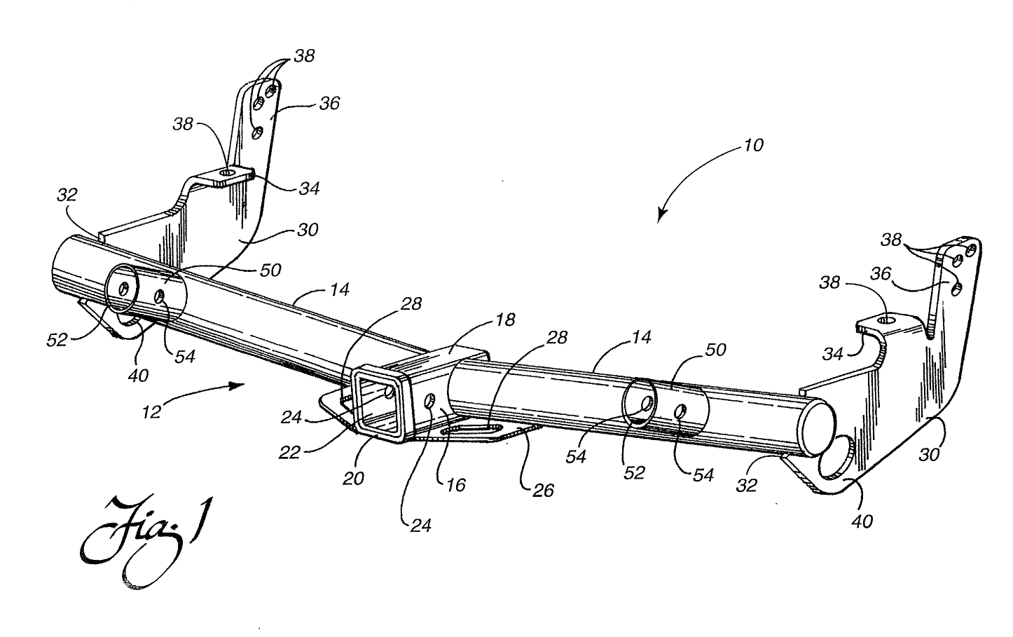

Reference is now made to FIG. 1 showing a receiver assembly, generally designated by reference numeral 10. The receiver assembly 10 includes a central frame member or cross member 12 preferably formed from a pair of tubular steel sections 14 welded to the opposing side walls 16 of a centrally located receiver box 18 so as to project outwardly in opposing directions. The tubular steel sections 14 may be formed with a round cross section as shown in the drawing figures, a square cross section or any other appropriate shape providing the necessary strength to function as a receiver assembly.

The receiver box 18 includes a reinforced lip 20 defining an opening leading to a hitch bar receiving cavity 22. Aligned apertures 24 in the opposing side walls 16 of the receiver box 18 allow the secure connection of a hitch bar in the receiver box in a manner well known in the art by means of a connecting pin and cooperating pin clip (not shown). A chain plate 26 of steel material is welded to the receiver box 18 and tubular steel sections 14 in order to strengthen the connection. As is known in the art, chain plate 26 includes two apertures 28. The safety chains of a trailer may be connected to the chain plate 26 through engagement in these apertures 28.

Vehicle mounting brackets 30 are mounted adjacent the distal end of each tubular section 14. More specifically, each mounting bracket 30 includes a notch 32 sized and shaped to receive the tubular section 14. The brackets 30 are welded to the tubular sections 14 in order to complete the connection. The mounting brackets 30 each include a mounting flange 34 and an upwardly projecting mounting lug 36, both with apertures 38. Nut and bolt fasteners (not shown) are extended through these apertures 38 and cooperating apertures drilled in the frame of the towing vehicle in order to mount the receiver assembly 10 thereto.

As also shown in FIG. 1, the trailer hitch assembly 10 incorporates a pair of tow hooks or loops 40, one integrally formed in each mounting bracket 30. The tow hooks 40 may be engaged with a tow line such as a rope, chain or cable in order to complete certain towing applications. As also shown, the receiver assembly 10 includes a pair of accessory receivers 50 carried on the tubular sections 14 of the central frame member 12. Each of the accessory receivers 50 is formed from a steel tube that is welded to the section 14 so that one accessory receiver is positioned between the receiver box 18 and each mounting bracket 30.

As shown, each accessory receiver 50 includes a circular port or opening 52 and cooperating aligned apertures 54 in the sidewall thereof to allow secure connection of a useful accessory by means of a connecting pin and pin clip of a type well known in the art such as utilized to secure the hitch bar in the receiver box 18. Each of the accessory receivers 50 is oriented with respect to the central frame member 12, receiver box 18 and the towing vehicle upon which the assembly 10 is mounted so as to be tilted upwardly and, therefore, readily accessible by the towing vehicle operator.

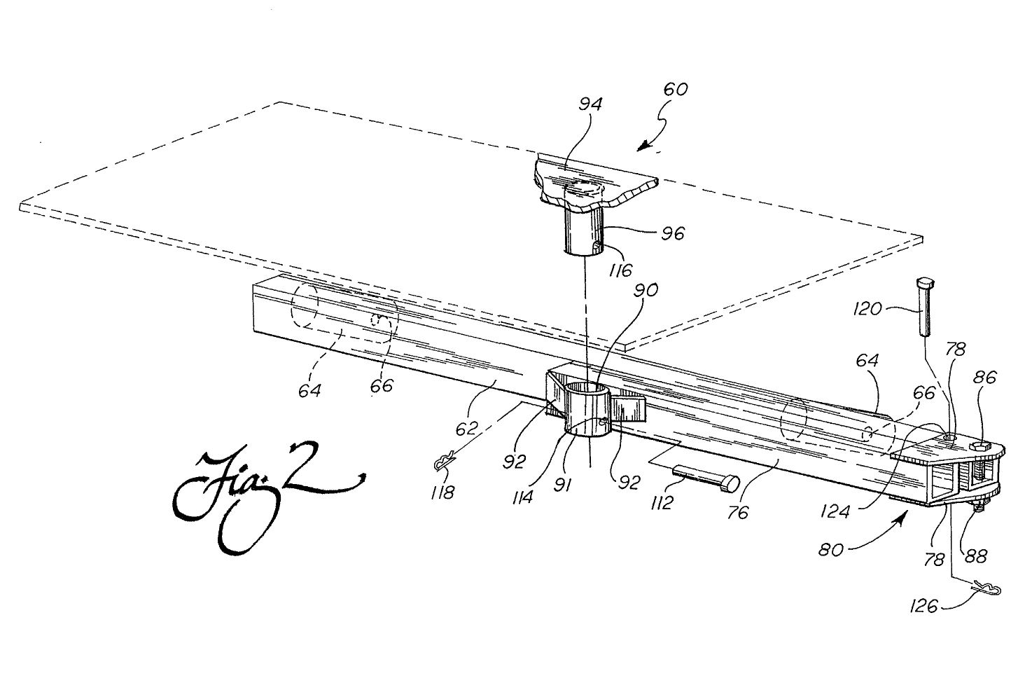

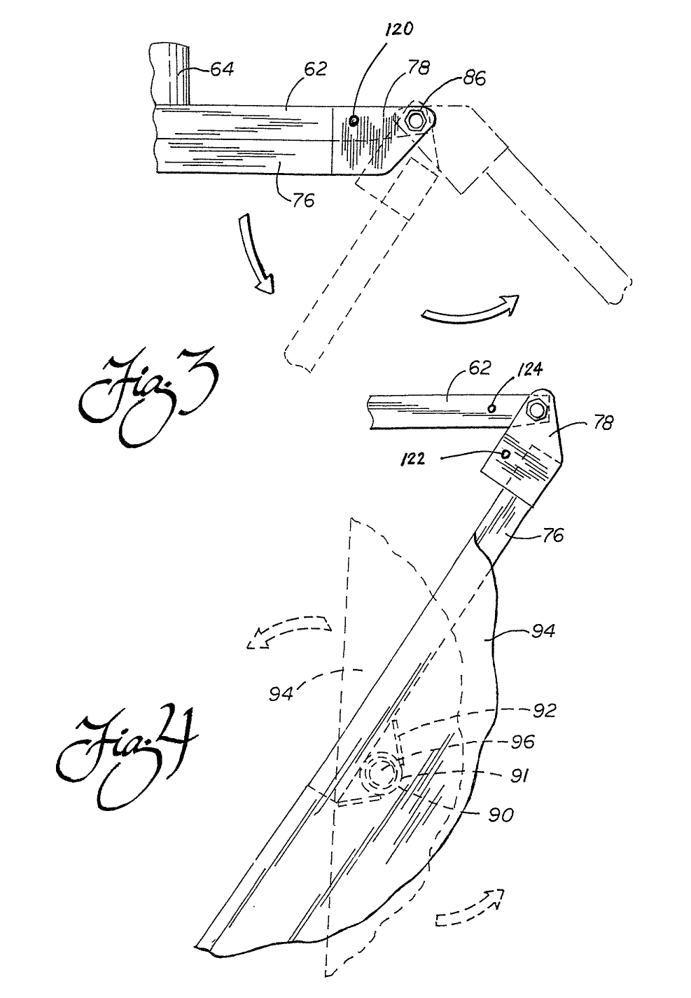

Reference is now made to FIGS. 2-6 which clearly illustrate the swinging article carrier assembly 60 of the present invention. The carrier assembly 60 includes an elongated mounting arm 62 which carries a pair of spaced, projecting mounting bars or lugs 64. The mounting arm 62 and the mounting bars 64 may be formed from tubular steel. The mounting bars 64 may be welded to the mounting arm 62 or connected by any other means appropriate for that purpose known in the art. The spacing between the mounting bars 64 corresponds to the spacing between the accessory receivers 50. Further, each of the mounting bars 64 has a circular cross section that is concentrically received and snugly fits within the accessory receivers 50. Of course, in the alternative, the bars 64 could just as easily be sized and shaped for receipt over the accessory receivers 50 if desired.

A pair of aligned mounting apertures 66 are provided at opposite sides of the mounting bars 64. When the bars 64 are properly inserted in the accessory receivers 50, the mounting apertures 66 in the bars are aligned with the cooperating apertures 54 in the sidewalls of the accessory receivers. A pin (not shown) of a type known in the art is then inserted through the aligned apertures 54, 66 of each of the connected bars 64 and accessory receivers 50 and a cooperating pin clip is utilized to secure each of the pins in position and complete the connection. More specifically, each pin may include a head at one end and a pin clip receiving groove or aperture adjacent the opposite end. Together, the head and pin clip prevent the pin from being inadvertently removed from the aligned apertures 54, 66 in the receiver 50 and the bar 64 respectively so as to complete a secure, positive and stable two-point connection.

The carrier assembly 60 also includes a swing arm 76 which may be constructed from steel or other high strength material. The swing arm 76 includes a pair of plates 78 at a first or proximal end. The plates 78 may be welded to the upper and lower faces of the swing arm 76. Together the plates 78 and the first or proximal end of the swing arm 76 form a clevis, generally designated by reference numeral 80.

As should be appreciated each of the plates 78 includes an aperture. The two apertures in the plates 78 are aligned. Additionally, it should be appreciated that one end of the mounting arm 62 includes aligned apertures in the upper and lower walls thereof. The swing arm 76 is pivotally mounted to the mounting arm 62 by means of the clevis 80 and a cooperating pivot pin/bolt 86 and lock nut 88.

Specifically, the swing arm 76 is manipulated with respect to the mounting arm 62 so that the plates 78 lap the upper and lower sides of the mounting arm and the apertures in the plates are aligned with the apertures in the mounting arm. The pivot pin/bolt 86 is then inserted through the aligned apertures and the lock nut 88 is secured to the pivot pin/bolt to complete the connection. Alternatively, a pin clip could be used to secure a smooth pivot pin 86 if desired.

As best shown in FIGS. 2 and 4 the second or distal end of the swing arm 76 carries a socket 90 which may, for example, be formed from a metal tube 91 that is circular in cross section and welded to the swing arm. Supports 92 at each side of the socket 90 are also welded between the swing arm 76 and the socket to strengthen the connection.

A base or platform 94 is secured to the swing arm 76. Specifically, the base 94 includes a stub shaft 96 which may be formed of steel and welded or fastened by other means to the bottom of the base 94. This stub shaft 96 is sized and shaped to be received in the socket 90 while freely rotating so as to allow the base to be rotated 360° around the axis of the stub shaft with respect to the socket 90 and the swing arm 76. Accordingly, the base 94 may be oriented at substantially any angle with respect to the swing arm 76.

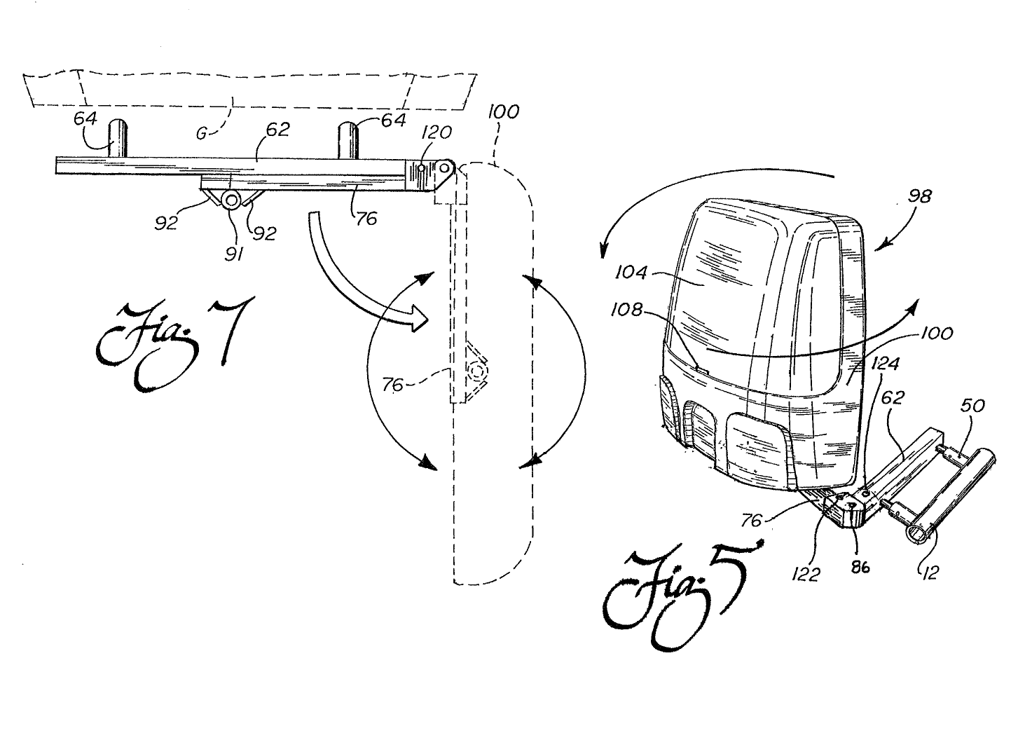

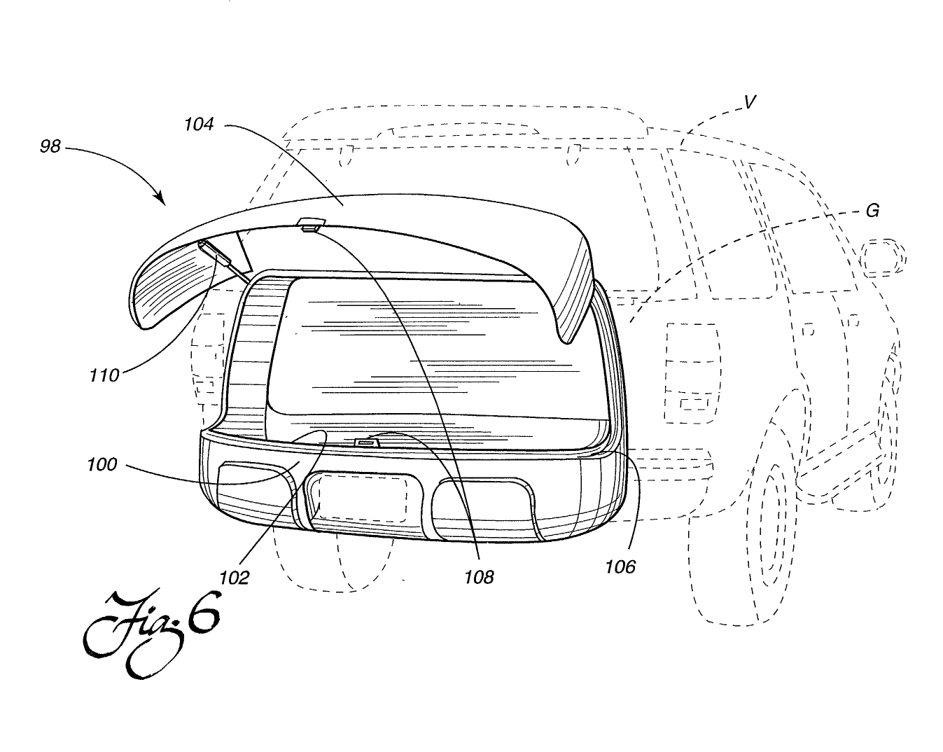

While it is possible to utilize the carrier assembly 60 as described above to carry substantially any article that might be desired to secure to the base 94, typically a user will find it desirable to secure an article carrier to the base by bolts, clamps or other appropriate means (not shown). As shown in Figures 5 and 6 the article carrier 98 of the illustrated embodiment includes a molded plastic or fiberglass body 100 which defines an interior cavity 102 that functions as a cargo compartment. An access door 104 may be pivotally secured to the body 100. When closed as shown in FIG. 5 the access door 104 forms a watertight seal with the sill 106 formed on the body 100 so as to provide weather protection to the cargo compartment. A lockable latch 108 allows the access door 104 to be secured in the closed position. When the access door 104 is opened as shown in FIG. 6, the cargo compartment 102 is accessible for loading and unloading. An air strut 110 may be provided to hold the access door 104 in the raised position during the loading and unloading operation.

As should be appreciated from reviewing FIG. 6, the tailgate G of the vehicle V is inaccessible when the article carrier 98 is in the transport or home position adjacent the body of the vehicle. However, by pivoting the swing arm 76 to a fully outboard position (see FIG. 7), the necessary clearance is provided to allow the operator to open and close the tailgate G of the vehicle V. When in the outboard position, it should be appreciated the article carrier 98 may be angularly oriented in substantially any direction about the 360° arc of the stub shaft 96. Accordingly, the opening through the access door 104 may be oriented, for example, at a 90° angle with respect to the open tailgate of the vehicle, parallel but rearward of that opening, 90° away from the open tailgate or anywhere inbetween. This provides a convenient loading feature unavailable with any prior art article carrier designs.

When loading is complete and it is desired to again secure the article carrier 98 in the home or transport position, the article carrier 98 is first pivoted into its home position with the longitudinal axis of the carrier aligned with the longitudinal axis of the swing arm 76 (note FIG. 7). Once the article carrier 98 and, therefore, the base 94 to which it is secured is in the home position, a pin 112 is inserted through cooperating apertures 114, 116 in the socket 90 and stub shaft 96 respectively to secure the base and the article carrier in the home position. A pin clip 118 received on the end of the pin 112 via a groove or aperture (not shown) completes the connection. Once the article carrier 98 is secured in the home position as described, the swing arm 76 is pivoted with respect to the mounting arm 62 until it is parallel to and right up against the mounting arm in the transport position (see FIG. 2). A pin 120 is then inserted in aligned apertures 122 and 124 in the plates 78 and the mounting arm 62 respectively. A pin clip 126 is then secured on the end of the pin 120 to secure the pin in position via a groove or aperture (not shown) and complete the connection. Now the article carrier 98 is locked in the transport position shown in FIG. 6 immediately behind the vehicle V.

While not shown, it should be appreciated that a pin or other structure could also be provided to connect the swing arm 76 with the mounting arm 62 adjacent the tube 91 for added support and stability.

The foregoing description of the preferred embodiment of this invention has been presented for purposes of illustration and description. It is not intended to be exhaustive or to limit the invention to the precise form disclosed. Obvious modifications or variations are possible in light of the above teachings.

For example, the invention could be secured to a receiver assembly not including a receiver box and, therefore, not equipped to support trailer towing. The mounting bars 64 could also be secured in a T-shaped adapter having a mounting bar sized and shaped to be secured in a standard hitch receiver opening such as shown at 18. This would allow the swinging article carrier assembly 60 to be mounted to a standard trailer hitch receiver not equipped with accessory receivers 50. Further, while an article carrier with an enclosed cargo compartment is illustrated, substantially any other form of article carrier could be mounted to the base. Examples of such article carriers include ski racks, bike racks, snow board racks and open baskets.

Appropriate equipment could also be mounted to the base. Such equipment includes, for example, winches, work tables and hoists. The listing of accessories and equipment that might be mounted to the swinging article carrier assembly 60 of the present invention as presented in this paragraph should be considered illustrative and not as restrictive. Further, while the accessory receivers 50 illustrated are hollow and include ports, it should be appreciated that they could be solid rods or bars so long as the mounting bars are appropriately configured for mating connection.

The embodiment illustrated was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

In the claims

1. A swinging article carrier assembly for mounting to a motor vehicle, comprising:
a mounting arm for securing to the vehicle;
a swing arm pivotally secured to said mounting arm; and
a base pivotally secured to said swing arm.

2. The carrier assembly of claim 1 further including an article carrier held on said base.

3. The carrier assembly of claim 2, wherein said article carrier has a cargo compartment with a watertight access door.

4. The carrier assembly of claim 1, wherein said swing arm is pivotally connected to said mounting arm at a first end and pivotally connected to said base at a second end.

5. The carrier assembly of claim 4, wherein said pivoting connection between said mounting arm and said swing arm is by a clevis and a pivot pin.

6. The carrier assembly of claim 5, wherein said pivoting connection between said swing arm and said base is by a cooperating socket and stub shaft.

7. The carrier assembly of claim 4, wherein said pivoting connection between said swing arm and said base is by a cooperating socket and stub shaft.

8. The carrier assembly of claim 1, wherein said mounting arm includes at least one mounting lug for securing to a receiver assembly carried on the vehicle.

9. The carrier assembly of claim 1, wherein said mounting arm includes a pair of mounting bars for securing to a receiver assembly carried on the vehicle.

10. The carrier assembly of claim 1, further including a first pin for securing said mounting arm and said swing arm in a transport position.

11. The carrier assembly of claim 10, further including a second pin for securing said base in a home position with respect to said swing arm.
